(19) United States
(12) Patent Application Publication
(10) Pub. No.: US 2008/0100561 A1
(43) Pub. Date: May 1, 2008

(54) System and Method for Managing LED Backlight Performance in a Display

(76) Inventors: Erin L. Price, Pflugerville, TX (US); Guangyong Zhu, Austin, TX (US)

Correspondence Address: HAMILTON & TERRILE, LLP, P.O. BOX 203518, AUSTIN, TX, 78720, US

(21) Appl. No.: 11/554,701

(22) Filed: Oct. 31, 2006

(51) Int. Cl. G09G 3/36

(52) U.S. Cl. 345/102

(57) ABSTRACT

Display backlight illumination provided from LEDs is managed by automatically identifying and compensating for LED failures. Shorts in one or more LEDs of an LED string are identified by comparing the drop in voltage across the LED string against an expected drop in voltage and are compensated for by increasing illumination from non-shorted LEDs. Open circuits in LED strings are identified where voltage drops to zero at termination of an LED string and are compensated for by increasing illumination from non-open circuit LED strings. LED failure information is available for presentation to a user, such as through a built-in test, to provide a more precise basis for repairing or replacing displays having limited illumination.

### BACKGROUND OF THE INVENTION

1. Field of the Invention

The present invention relates in general to the field of information handling system displays, and more particularly to a system and method for managing LED backlight performance in a display.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

One goal of information handling systems is to present visual images from visual information generated by the information handling system. Liquid Crystal Displays (LCDs) offer a number of advantages that have made them a popular choice for the presentation of visual information as visual images. LCDs generate images with pixels disposed in a panel that vary the color of a white backlight that passes through the panel. One advantage of an LCD is that high quality resolution visual images are presentable from a relatively thin panel. Another advantage of an LCD is that the backlight typically uses reduced amounts of power relative to other types of illumination in other types of displays, such as plasma and rear projection displays. These advantages and others have made LCDs a natural choice for presenting images from portable information handling systems since portable information handling systems have small profiles and depend on internal battery power. However, LCDs are often also selected for use as external peripherals for desktop information handling systems as well as for use as televisions.

Typically, LCDs have used Cold Cathode Florescent Lamps (CCFL) to provide white backlight to a panel. Although CCFLs have relatively small power demands and provide reliable backlight, they generally use relatively high alternating voltages that require conversion by an inverter associated with the panel. One attractive alternative to CCFLs are light emitting diodes (LEDs) that use direct current voltage applied to semiconductor material to produce light. LEDs do not require conversion of direct current power to alternating current power and use even less power than CCFLs. To provide backlight to a typical LCD, four to six strings of LEDs are distributed across the back of the panel with each string having ten or so LEDs. Two types of LEDs are available to provide backlight: white LEDs (WLEDs) that produce white light with a blue LED having a phosphor coating; and Red Green and Blue LEDs (RGB LEDs) that use separate red, green and blue LEDs that illuminated together provide white backlight. One difficulty with LEDs as compared to CCFLs is that the use of plural LEDs instead of a single light source can make the generation of an evenly-distributed backlight more difficult. Further, failure analysis in the event of poor backlight performance tends to present increased complexity with LEDs as compared to CCFLs since failure of a CCFL typically results in no illumination while partial failure of LEDs can still produce illumination that may appear to an end user as having poor quality.

### SUMMARY OF THE INVENTION

Therefore a need has arisen for a system and method which manages LED backlight performance in a display.

In accordance with the present invention, a system and method are provided which substantially reduce the disadvantages and problems associated with previous methods and systems for managing display backlight performance. LEDs of a display backlight are automatically monitored for failures by monitoring voltage at termination of the LED power circuit. Failure of one or more LEDs is automatically compensated by altering illumination from other LEDs of the backlight system.

More specifically, an information handling system has plural processing components that generate visual information for presentation as visual images at a display, such as an LCD. Pixels of the display present the visual image with backlight illuminated from the rear of the display. An LED backlight system has plural LED strings to provide illumination with each LED string having plural LEDs. An LED monitor detects the voltage and current levels at the termination of the LED strings. A balancing circuit interfaced with the LED monitor adjusts the power provided to the LED strings based upon the detected current and voltage. The balancing circuit analyzes the voltage drop across the LED strings to determine LED failures. A reduced voltage drop indicated by an increased terminating voltage indicates a short at an LED. A voltage drop to zero indicates an open circuit at the LED string and failure of all LEDs in the string. The LED balancing circuit compensates for failed LEDs by increasing illumination from non-failed LEDs, or, alternatively, provides failure information to the information handling system so that processing components or the operating system can compensate with additional illumination. In addition, the LED balancing circuit provides LED failure information to other processing components so that the identity of the failed LEDs and types of failures is available to the end user for fault analysis and physical correction of the failures.

The present invention provides a number of important technical advantages. One example of an important technical advantage is that LED backlight failures are automatically detected, analyzed and identified for corrective action. Corrective actions include improved response by technicians to correct failures by providing accurate on-board diagnostics information presented at the display or through a network connection. Corrective actions also include automated alterations to properly-operating LEDs to minimize the impact of failed LEDs on backlight illumination. Overall end user satisfaction with visual images presented by an LCD remains high despite partial failures, and correction of failures has reduced complexity for technicians with detailed information as to the types and numbers of failures.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 depicts a block diagram of an information handling system having automated LED backlight failure detection and compensation; and

FIG. 2 depicts a circuit diagram of a system for managing LED backlight performance of a display.

### DETAILED DESCRIPTION

Information handling system displays having LED backlights provide automated LED fault detection and compensation to maintain desired display illumination. For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

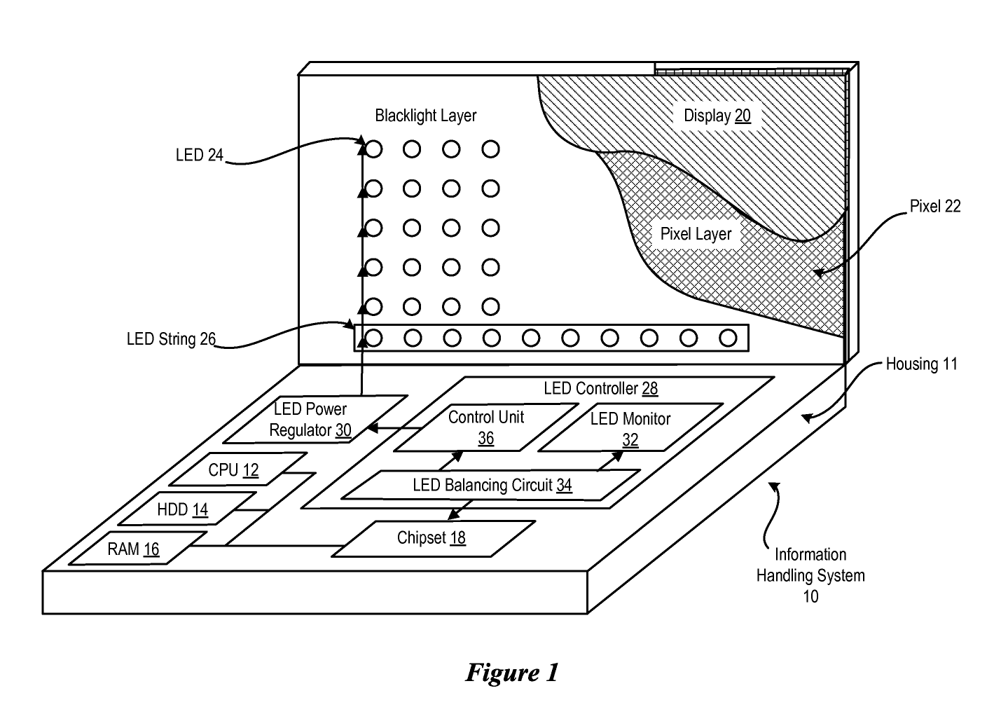

Referring now to FIG. 1, a block diagram depicts an information handling system 10 having automated LED backlight failure detection and compensation. Information handling system 10 has plural processing components disposed in a housing 11, the processing components cooperating to generate visual information for presentation as visual images, such as a CPU 12, hard disk drive 14, RAM 16 and chipset 18. The visual information generated from the processing components is communicated to display 20 for presentation as visual images through pixels 22. For example, graphics processing components in chipset 18 provide settings for liquid crystals associated with pixels 22 that determine the color of backlight passing from the rear of display 20 through pixels 22 to the front of display 20. Backlight to illuminate the visual image is provided by LEDs 24 arrayed in LED strings 26 having LEDs 24 connected in parallel. For example, a portable information handling system 10 has four to six LED strings 26 with each string having 10 LEDs 24. Typically, displays 20 for portable information handling systems 10 place LED strings on the bottom base of display 20 in the placed of a CCFL and use light guides to distribute backlight evenly. Alternatively, LEDs 24 can be distributed across the back surface of display 20 to distribute the backlight across display 20, such as with larger display peripherals or televisions.

The amount and balance of illumination provided by LEDs 24 is managed by an LED controller 28, located on display 20 or the motherboard of information handling system 10, that controls electrical power provided from an LED power regulator 30. Current levels measured at the termination of each LED string 26 by an LED monitor 32 are balanced by an LED balancing circuit 34 to provide desired illumination at each LED string 26 through a control unit 36, which controls the current levels provided from LED power regulator 30. In addition, LED monitor 32 measures the voltage at the termination of each LED string 26 so that LED balancing circuit 34 can analyze, identify and take corrective action for faults in one or more of the LEDs 24. For example, if a short occurs in an LED 24, voltage at the string termination 27 of LED string 26 will increase more than normal. An increased voltage level at the termination 27 of a string 26 is analyzed by LED balancing circuit 34 as a short and compensated for by having control unit 34 increase illumination from non-shorted LEDs 24 by an amount that offsets the number of shorted LEDs 24. If an open circuit occurs in an LED string 26, the voltage measured by LED monitor 32 for that string is zero. LED balancing circuit 34 analyzes zero voltage at termination of an LED string 26 as an open circuit and compensates for the open circuit by increasing illumination from non-open LED strings 26. In the event that a failed LED 24 is a particular color, such as red, green or blue, LED balancing circuit 34 compensates for the loss of the identified color by increasing illumination from similarly-colored LEDs. In addition to compensating for detected faults, LED balancing circuit 34 can initiate an alert of the fault, such as through presentation of a fault message at display 20 or communication of fault information to a network location. Alternatively, as part of a built-in self-test or system start-up, processing components of information handling system 10 inquire of LED controller 28 to retrieve the status of LEDs 24 so the processing components can adjust brightness settings to compensate for LED failures and issue fault messages.

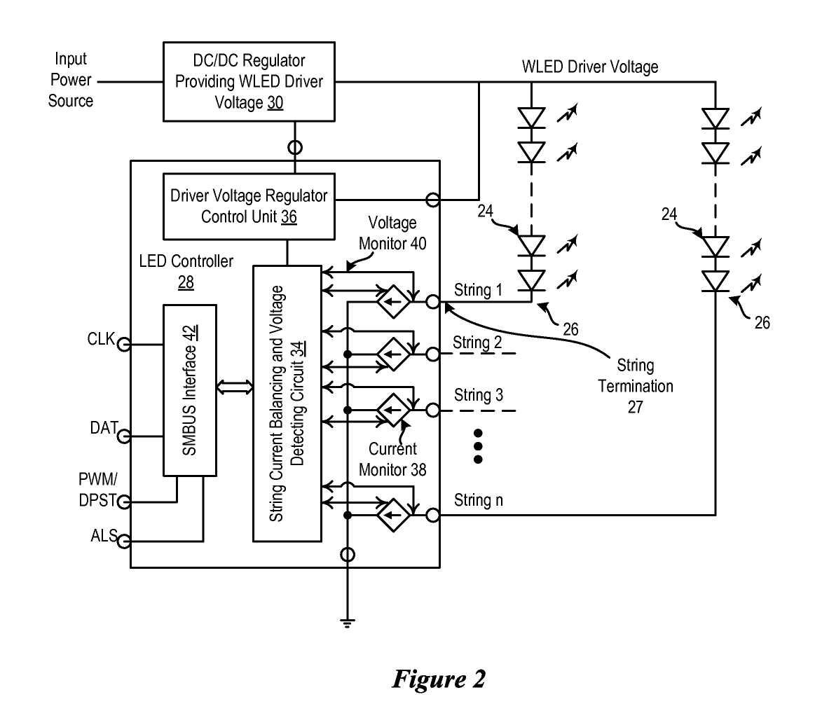

Referring now to FIG. 2, a circuit diagram depicts a system for managing LED backlight performance of a display. Power from an input source is provided to LED strings 26 by a DC/DC regulator providing a desired driver voltage. As an example, each operating WLED 24 of a string 26 from one LED manufacturer produces a voltage drop of approximately 3.6V. Thus, at the termination 27 of an LED string 26, the voltage is approximately equal to the drive voltage minus the number of operating LEDs 24 times the forward voltage drop of each LED 24, such as the 3.6V drop associated with a typical WLED. A voltage monitor 40 provides the voltage at termination of each LED string 26 to LED balancing circuit 34 so that LED balancing circuit 34 can compare the drop of the terminating voltage to ground with an expected result based on the number of LEDs 24 in the LED string 26. An increased termination voltage indicates a short in an LED 24 with the number of shorts determined by the multiple of the excess terminating voltage times 3.6V. A termination voltage of zero at an LED string 26 indicates an open circuit fault that removes illumination from all LEDs 24 of that string 26. Current monitors 38 provide the current at termination of each LED string 26 to LED balancing circuit 34 which monitors the termination current and voltage to analyze and identify faults and to provide compensation commands to regulator 34.

Compensation commands by balancing circuit 34 attempt to provide improved backlight illumination quality in light of identified failures by adjusting the illumination of non-failed LEDs 24. For example, if 4 of 40 LEDs have failed to reduce illumination by 10%, then the remaining LEDs have their illumination increased to provide an illumination level requested by an end user. If an end user requests illumination at a 20% brightness level, then balancing circuit 34 illuminates the operational LEDs at a 22.2% brightness level to achieve desired brightness. An SMBus interface 42 or similar management bus interface allows communication of LED fault information to information handling system processing components in support of fault alerts and built-in self-tests of the display backlight system. Precise information about LED failures provides a basis for definitive corrective action. For example, a threshold level of allowed LED failures might be set which, if exceeded, will result in replacement of the display due to excessive degradation of display quality.

Although the present invention has been described in detail, it should be understood that various changes, substitutions and alterations can be made hereto without departing from the spirit and scope of the invention as defined by the appended claims.

What is claimed is:

1. An information handling system comprising:
plural processing components operable to generate visual information;
a display interfaced with the processing components and operable to generate a visual image from the visual information;
an LED backlight operable to illuminate the visual image, the LED backlight having plural LEDs;
an LED power regulator operable to provide power to illuminate the LEDS;
an LED controller interfaced with the LED power regulator, the LED controller operable to manage the power provided by the LED power regulator to the LEDs; and
an LED monitor interfaced with the LED controller and the LEDs, the LED monitor operable to analyze voltage between the LEDs termination and ground to determine LED faults.

2. The information handling system of claim 1 further comprising an LED error correction module interfaced with the LED monitor and the LED controller, the LED error correction module operable to alter the power provided to one or more LEDs to compensate for a determined LED fault.

3. The information handling system of claim 1 wherein the LED monitor analyzes voltage between the LEDs termination and ground as above a predetermined amount to determine an LED short.

4. The information handling system of claim 1 wherein the LED monitor analyzes voltage between the LEDs termination and ground as zero to determine an LED open circuit.

5. The information handling system of claim 1 wherein the LEDs comprise WLEDs.

6. The information handling system of claim 1 wherein the LEDs comprise RGBLEDs.

7. The information handling system of claim 1 further comprising a portable housing supporting the processing components and the display.

8. The information handling system of claim 1 wherein the display further comprises an LCD.

9. A method for managing LED backlight performance in a display, the method comprising:
applying electrical power to plural LEDs to provide backlight to the display;
monitoring the voltage change across the LEDs; and
analyzing one or more LEDs as failed if the voltage change has a predetermined value.

10. The method of claim 9 wherein analyzing one or more LEDs as failed further comprises analyzing one or more LEDs as open if the voltage between the LEDs termination and ground is zero.

11. The method of claim 9 wherein analyzing one or more LEDs as failed further comprises analyzing one or more LEDs as shorted if the voltage between the LEDs termination and ground increases by a predetermined amount.

12. The method of claim 11 wherein the predetermined amount comprises 3.6V.

13. The method of claim 9 further comprising compensating for one or more failed LEDs by altering the electrical power applied to one or more non-failed LEDs.

14. The method of claim 13 wherein the LEDs comprise RGBLEDs having red, green and blue LEDs, the method further comprising:
determining that the one or more failed LEDs comprise a red LED; and
compensating for the failed red LED by increasing the electrical power applied to one or more non-failed red LEDs.

15. The method of claim 9 further comprising presenting a message at the display having an alert associated with the failure.

16. The method of claim 9 further comprising communicating information associated with the failure to a network location.

17. A system for managing LED backlight performance for an LCD, the system comprising:
a power regulator operable to provide electrical power to plural LED strings, each LED string having plural LEDs;
a control unit interfaced with the power regulator and operable to alter the electrical power provided by the power regulator to the plural LED strings;
a voltage detectors operable to measure voltage drop across each LED string terminal to ground; and
a balancing circuit interfaced with the control unit and the voltage detectors, the balancing circuit operable to analyze the voltage drop associated with each LED string terminal to ground to identify faults associated with each LED string.

18. The system of claim 17 wherein the balancing circuit is further operable to analyze a short in an LED if the voltage drop at the terminal to ground is greater than a predetermined amount.

19. The system of claim 17 wherein the balancing circuit is further operable to analyze an open circuit in an LED if the voltage drop at the terminal to ground is less than a predetermined amount.

20. The system of claim 17 wherein the balancing circuit is further operable to manage the electrical power set by the control unit to compensate for LEDs analyzed as having a fault.
